(19) United States
(12) Patent Application Publication
(10) Pub. No.: US 2007/0171275 A1
(43) Pub. Date: Jul. 26, 2007

(54) Three Dimensional Videoconferencing

(76) Inventor: Michael L. Kenoyer, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/611,268

(22) Filed: Dec. 15, 2006

Related U.S. Application Data
(60) Provisional application No. 60/761,868, filed on Jan. 24, 2006.

(51) Int. Cl. H04N 7/14

(52) U.S. Cl. 348/14.08

(57) ABSTRACT

In various embodiments, a videoconferencing system may include a video capture device for capturing an image and a computer system for processing the captured image to produce a 3-D image. In some embodiments, the computer system may be coupled to the video capture device through a network and may process the image by forming image portions for projecting onto a moving surface. In some embodiments, the moving surface may move and a projector may project the image portions onto the moving surface. In some embodiments, the image portions projected onto the moving surface may appear as a 3-D image to a participant in the videoconference. In some embodiments, the 3-D image may be displayed through 3-D goggles or using other 3-D mediums.

### PRIORITY CLAIM

This application claims priority to U.S. Provisional Patent Application Ser. No. 60/761,868 titled “Three Dimensional Videoconferencing”, which was filed Jan. 24, 2006, whose inventor is Michael L. Kenoyer and which is hereby incorporated by reference in its entirety as though fully and completely set forth herein.

### BACKGROUND OF THE INVENTION

1. Field of the Invention

The present invention relates generally to conferencing and, more specifically, to videoconferencing.

2. Description of the Related Art

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to another (remote) participant. Each videoconferencing system may also include a display and speaker to reproduce video and audio received from a remote participant. Each videoconferencing system may also have a computer system to allow additional functionality into the videoconference. For example, additional functionality may include data conferencing (including displaying and/or modifying a document for both participants during the conference).

### SUMMARY OF THE INVENTION

In various embodiments, videoconferencing systems may capture and display three-dimensional (3-D) images of videoconference participants. In some embodiments, an image of a local participant may be captured and sent to a remote videoconference site. One or more cameras may capture image data of the local participant. The image data may then be sent to another participant location (e.g., across a network). In some embodiments, the captured image data may be sent across a network for processing into 3-D images at the remote participant location where the 3-D images are displayed or the captured image data may be processed at the local participant location where the images are captured, and then transmitted over the network to the remote participant location for 3-D display. In some embodiments, the computer system or device that processes the captured image data for display of 3-D images may be remote from each of the local and remote participant locations.

In some embodiments, the image data may be processed according to a 3-D reproduction medium to be used in displaying the image. For example, if the image is to be projected onto a rotating disc, then a series of projection images may be processed by a computer to coincide with the positions of the rotating disc. The delay between the projected images may not be perceivable or may be insignificantly perceivable to a remote participant such that the remote participant perceives the image as a 3-D image. In some embodiments, the 3-D reproduction medium may include virtual reality goggles. In some embodiments, the 3-D image may be displayed on an autostereoscopic display. Other display types are also contemplated.

### BRIEF DESCRIPTION OF THE DRAWINGS

A better understanding of the present invention may be obtained when the following detailed description is considered in conjunction with the following drawings, in which:

FIG. 1 illustrates a videoconferencing network, according to an embodiment;

FIG. 2 illustrates a participant location, according to an embodiment;

FIG. 3 illustrates a method for providing a 3-D videoconference, according to an embodiment;

FIG. 4 illustrates a 3-D videoconference using a rotating disc/projector system, according to an embodiment;

FIG. 5 illustrates a 3-D videoconference using a rotating panel, according to an embodiment;

FIG. 6 illustrates a 3-D videoconference using an oscillating panel, according to an embodiment;

FIG. 7 illustrates a 3-D videoconference using multiple rotating panels, according to an embodiment;

FIG. 8 illustrates a virtual 3-D videoconference, according to an embodiment;

FIG. 9 illustrates a local and remote autostereoscopic display, according to an embodiment;

FIG. 10 illustrates a remote autostereoscopic display with repositioned cameras, according to an embodiment;

FIG. 11 illustrates a remote autostereoscopic display with cameras that have moved apart, according to an embodiment; and

FIG. 12 illustrates a remote autostereoscopic display, according to another embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE INVENTION

### Incorporation by Reference

U.S. patent application titled “Speakerphone”, Ser. No. 11/251,084, which was filed Oct. 14, 2005, whose inventor is William V. Oxford is hereby incorporated by reference in its entirety as though fully and completely set forth herein.

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

U.S. patent application titled “Speakerphone Supporting Video and Audio Features”, Ser. No. 11/251,086, which was filed Oct. 14, 2005, whose inventors are Michael L. Kenoyer, Craig B. Malloy and Wayne E. Mock is hereby incorporated by reference in its entirety as though fully and completely set forth herein.

U.S. patent application titled “High Definition Camera Pan Tilt Mechanism”, Ser. No. 11/251,083, which was filed Oct. 14, 2005, whose inventors are Michael L. Kenoyer, William V. Oxford, Patrick D. Vanderwilt, Hans-Christoph Haenlein, Branko Lukic and Jonathan I. Kaplan, is hereby incorporated by reference in its entirety as though fully and completely set forth herein.

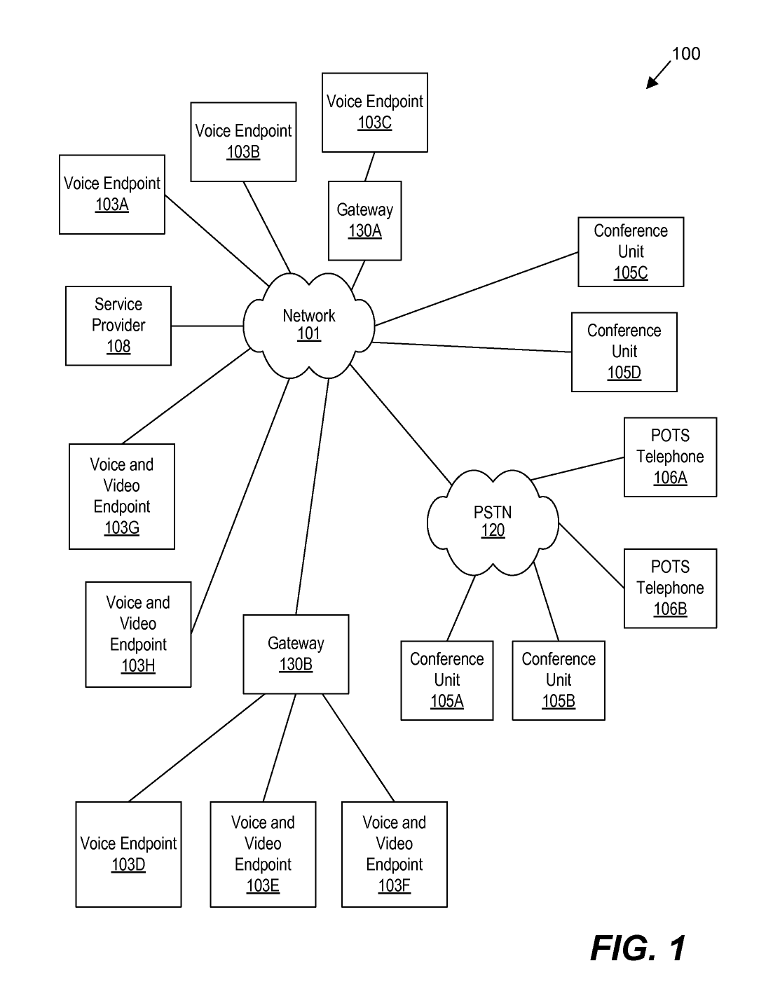

FIG. 1 illustrates an embodiment of a videoconferencing system 100. Videoconferencing system 100 comprises a plurality of participant locations or endpoints. FIG. 1 illustrates an exemplary embodiment of a videoconferencing system 100 which may include a network 101, endpoints 103A-103H (e.g., audio and/or videoconferencing systems), gateways 130A-130B, a service provider 108 (e.g., a multipoint control unit (MCU)), a public switched telephone network (PSTN) 120, conference units 105A-105D, and plain old telephone system (POTS) telephones 106A-106B. Endpoints 103C and 103D-103H may be coupled to network 101 via gateways 130A and 130B, respectively, and gateways 130A and 130B may each include firewall, network address translation (NAT), packet filter, and/or proxy mechanisms, among others. Conference units 105A-105B and POTS telephones 106A-106B may be coupled to network 101 via PSTN 120. In some embodiments, conference units 105A-105B may each be coupled to PSTN 120 via an Integrated Services Digital Network (ISDN) connection, and each may include and/or implement H.320 capabilities. In various embodiments, video and audio conferencing may be implemented over various types of networked devices.

In some embodiments, endpoints 103A-103H, gateways 130A-130B, conference units 105C-105D, and service provider 108 may each include various wireless or wired communication devices that implement various types of communication, such as wired Ethernet, wireless Ethernet (e.g., IEEE 802.11), IEEE 802.16, paging logic, RF (radio frequency) communication logic, a modem, a digital subscriber line (DSL) device, a cable (television) modem, an ISDN device, an ATM (asynchronous transfer mode) device, a satellite transceiver device, a parallel or serial port bus interface, and/or other type of communication device or method.

In various embodiments, the methods and/or systems described may be used to implement connectivity between or among two or more participant locations or endpoints, each having voice and/or video devices (e.g., endpoints 103A-103H, conference units 105A-105D, POTS telephones 106A-106B, etc.) that communicate through various networks (e.g., network 101, PSTN 120, the Internet, etc.).

Endpoints 103A-103C may include voice conferencing capabilities and include or be coupled to various audio devices (e.g., microphones, audio input devices, speakers, audio output devices, telephones, speaker telephones, etc.). Endpoints 103D-103H may include voice and video communications capabilities (e.g., videoconferencing capabilities) and include or be coupled to various audio devices (e.g., microphones, audio input devices, speakers, audio output devices, telephones, speaker telephones, etc.) and include or be coupled to various video devices (e.g., monitors, projectors, displays, televisions, video output devices, video input devices, cameras, etc.). In some embodiments, endpoints 103A-103H may comprise various ports for coupling to one or more devices (e.g., audio devices, video devices, etc.) and/or to one or more networks.

Conference units 105A-105D may include voice and/or videoconferencing capabilities and include or be coupled to various audio devices (e.g., microphones, audio input devices, speakers, audio output devices, telephones, speaker telephones, etc.) and/or include or be coupled to various video devices (e.g., monitors, projectors, displays, televisions, video output devices, video input devices, cameras, etc.). In some embodiments, endpoints 103A-103H and/or conference units 105A-105D may include and/or implement various network media communication capabilities. For example, endpoints 103A-103H and/or conference units 105C-105D may each include and/or implement one or more real time protocols, e.g., session initiation protocol (SIP), H.261, H.263, H.264, H.323, among others. For example, endpoints 103A-103H may implement H.264 encoding for high definition video streams.

In various embodiments, a codec may implement a real time transmission protocol. In some embodiments, a codec (which may mean short for “compressor/decompressor”) may comprise any system and/or method for encoding and/or decoding (e.g., compressing and decompressing) data (e.g., audio and/or video data). For example, communication applications may use codecs to convert an analog signal to a digital signal for transmitting over various digital networks (e.g., network 101, PSTN 120, the Internet, etc.) and to convert a received digital signal to an analog signal. In various embodiments, codecs may be implemented in software, hardware, or a combination of both. Some codecs for computer video and/or audio may include Moving Picture Experts Group (MPEG), Indeo™, and Cinepak™, among others.

A participant location may include a camera for acquiring high resolution or high definition (e.g., HDTV compatible) signals. A participant location may include a high definition display (e.g., an HDTV display or high definition autostereoscopic display), for displaying received video signals in a high definition format. In one embodiment the network 101 may be 1.5 MB or less (e.g., T1 or less). In another embodiment, the network is 2 MB or less.

One of the embodiments comprises a videoconferencing system that is designed to operate with network infrastructures that support T1 capabilities or less, e.g., 1.5 mega-bits per second or less in one embodiment, and 2 mega-bits per second in other embodiments. The videoconferencing system may support high definition capabilities. The term “high resolution” includes displays with resolution of 1280×720 pixels and higher. In one embodiment, high-definition resolution may comprise 1280×720 progressive scans at 60 frames per second, or 1920×1080 interlaced or 1920×1080 progressive. Thus, an embodiment may comprise a videoconferencing system with high definition “e.g. similar to HDTV” display capabilities using network infrastructures with bandwidths T1 capability or less. The term “high-definition” is intended to have the full breath of its ordinary meaning and includes “high resolution”.

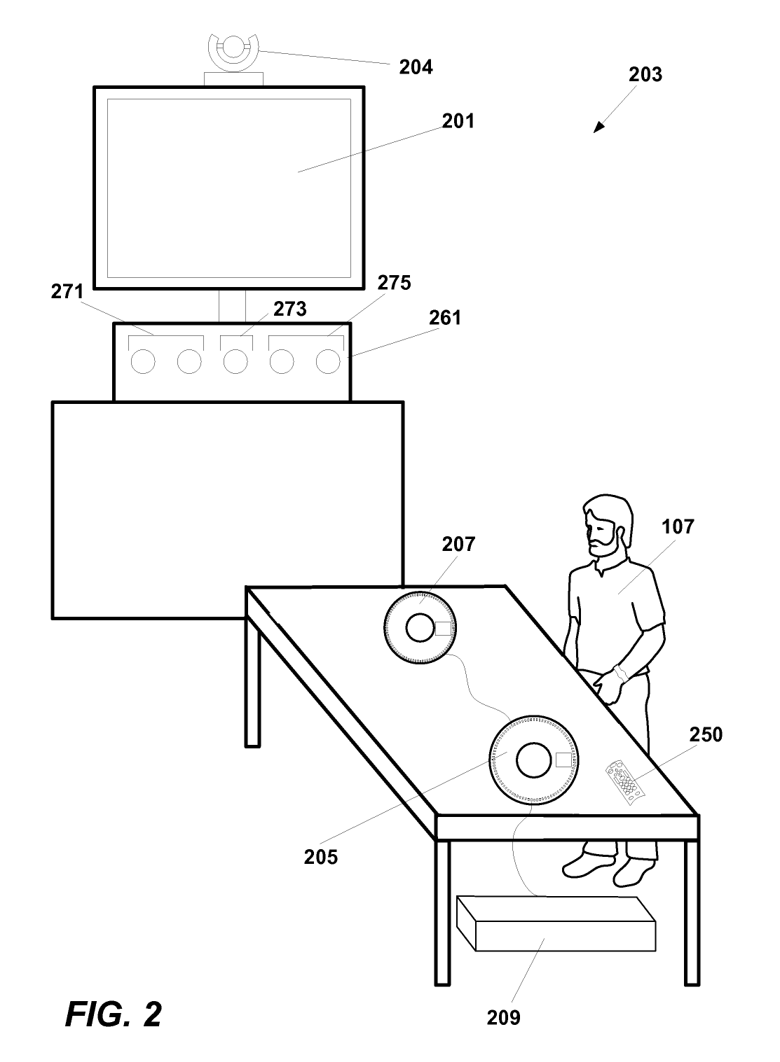

FIG. 2 illustrates an embodiment of a participant location, also referred to as an endpoint or conferencing unit (e.g., a videoconferencing system). In some embodiments, the videoconference system may have a system codec 209 to manage both a speakerphone 205/207 and a videoconferencing system 203. For example, a speakerphone 205/207 and a videoconferencing system 203 may be coupled to the codec 209 and may receive audio and/or video signals from the system codec 209.

In some embodiments, the participant location may include a video capture device (such as a high definition camera 204) for capturing images of the participant location. The participant location may also include a high definition display 201 (e.g., an HDTV display or an autostereoscopic display). High definition images acquired by the camera 204 may be displayed locally on the display 201 and may also be encoded and transmitted to other participant locations in the videoconference.

The participant location may also include a sound system 261. The sound system 261 may include multiple speakers including left speakers 271, center speaker 273, and right speakers 275. Other numbers of speakers and other speaker configurations may also be used. In some embodiments, the videoconferencing system 203 may include a camera 204 for capturing video of the conference site. In some embodiments, the videoconferencing system 203 may include one or more speakerphones 205/207 which may be daisy chained together.

The videoconferencing system components (e.g., the camera 204, display 201, sound system 261, and speakerphones 205/207) may be coupled to a system codec 209. The system codec 209 may receive audio and/or video data from a network (e.g., network 101). The system codec 209 may send the audio to the speakerphone 205/207 and/or sound system 261 and the video to the display 201. The received video may be high definition video that is displayed on the high definition display 201. The system codec 209 may also receive video data from the camera 204 and audio data from the speakerphones 205/207 and transmit the video and/or audio data over the network to another conferencing system. In some embodiments, the conferencing system may be controlled by a participant 107 through the user input components (e.g., buttons) on the speakerphones 205/207 and/or remote control 250. Other system interfaces may also be used.

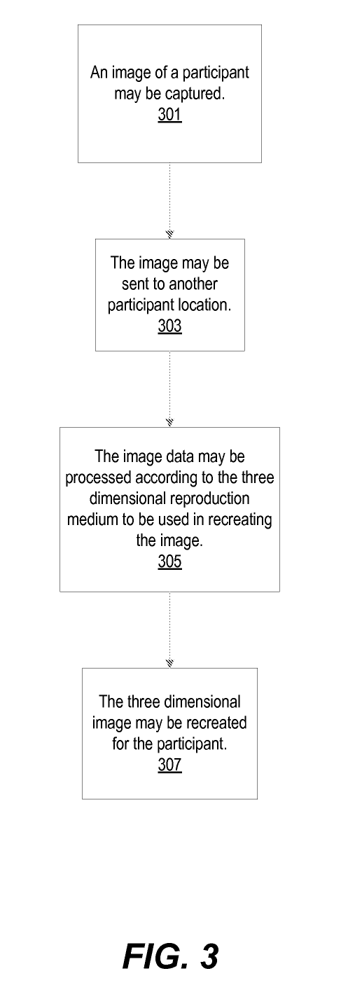

FIG. 3 illustrates an embodiment of a method for providing a 3-D videoconference. It should be noted that in various embodiments of the methods described below, one or more of the elements described may be performed concurrently, in a different order than shown, or may be omitted entirely. Other additional elements may also be performed as desired.

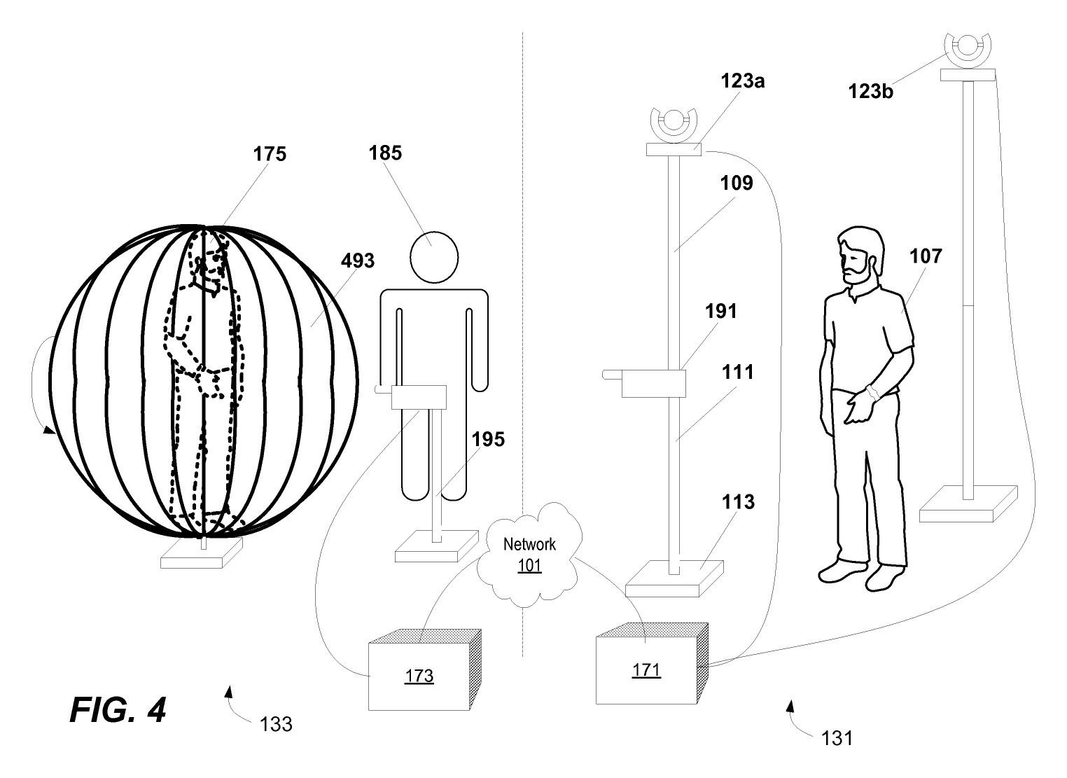

At 301, an image of a local participant 107 (e.g., see FIG. 4) may be captured. For example, one or more cameras 123a,b may capture image data of local participant 107. In some embodiments, multiple cameras 123a,b positioned at different points relative to the local participant 107 may be used to capture images of the local participant 107. In various embodiments 2, 3, 4, or more cameras may be used (e.g., in a camera array). These multiple images may be used to create 3-D image data of the local participant 107. In some embodiments, a moving camera (e.g., a camera rotating around the local participant 107) may be used to capture various images of the local participant 107 to create a 3-D image. In some embodiments, the camera 123 may be a video camera such as an analog or digital camera for capturing images. Other cameras are also contemplated.

As used herein, the term “3-D image” may refer to a virtual 3-D image (e.g., an image created using one or more 2-D images in a manner that appears as a 3-D image) or an actual 3-D image (e.g., holograms). 3-D images may be formed by using various techniques to provide depth cues (e.g., accommodation, convergence, binocular disparity, motion parallax, linear perspective, shading and shadowing, aerial perspective, interposition, retinal image size, texture gradient, color, etc.) 3-D displays may include, for example, stereo pair displays, holographic displays, and multiplanar or volumetric displays.

At 303, the image data may be sent to another participant location. For example, the data for the image may be sent across a network 101 to a remote participant location 133. In one embodiment, the captured image data may be sent across a network 101 for processing into 3-D images at the remote participant location 133 where the 3-D images are displayed. In another embodiment, the captured image data may be processed at the local participant location 131 where it is captured, and then transmitted over the network 101 to the remote participant location 133 for 3-D display. In some embodiments, the computer system or device which processes the captured image data for display of 3-D images may be remote from each of the local and remote participant locations, (e.g., may be coupled to the video capture device through a network 101, may receive and process the received image, and may generate signals corresponding to the 3-D image over a network 101 to send to the remote participant location 133).

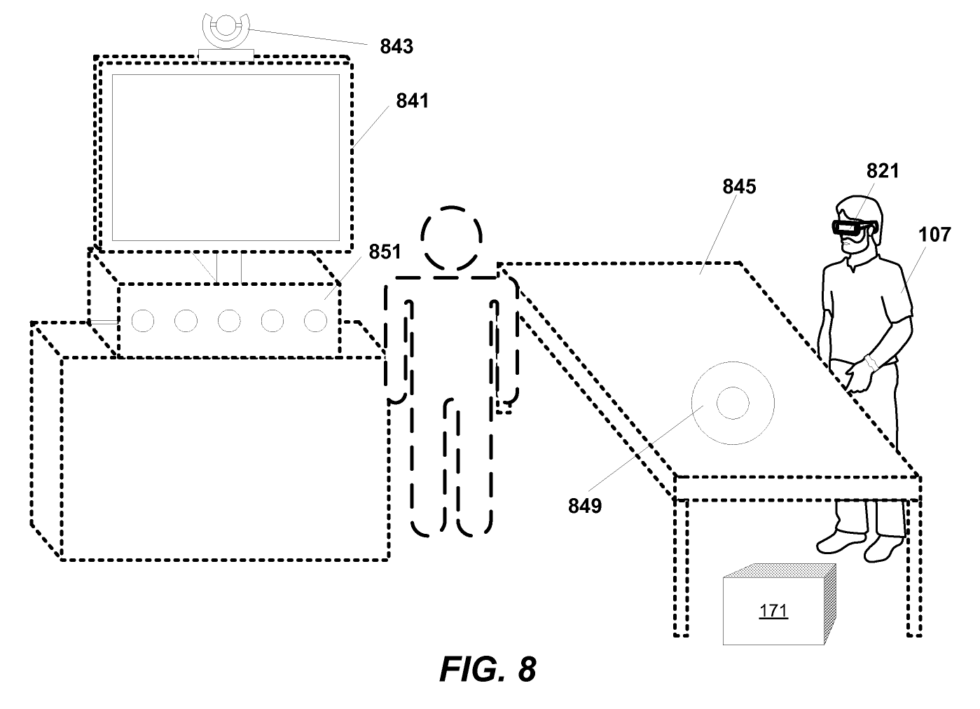

At 305, the image data may be processed according to a 3-D reproduction medium to be used in displaying the image. For example, if the image is to be projected onto a rotating disc 493 (e.g., as seen in FIG. 4), then a series of projection images may be processed by a computer to coincide with the positions of the rotating disc 493. The delay between the projected images may not be perceivable or may be insignificantly perceivable to a remote participant 185 such that the remote participant 185 perceives the image 175 as a 3-D image. FIGS. 4-8 illustrate various videoconferencing systems according to various embodiments. For example, in some embodiments, the 3-D reproduction medium may include virtual reality goggles (e.g., see goggles 821 in FIG. 8). The images may be processed to form 3-D images for the local participant 107 wearing the goggles 821.

In 305, the processing of the image data may comprise various different techniques, e.g., as shown in U.S. Pat. Nos. 6,944,259; 6,909,552; 6,813,083; 6,314,211; 5,581,671; 6,195,184; and 5,239,623, all of which are hereby incorporated by reference as though fully and completely set forth herein.

At 307, the 3-D image may be displayed for the participant. For example, the processed image(s) may be projected for viewing by a remote participant 185 at the remote location 133. The remote participant 185 at remote location 133 may view the images 175 of the local participant 107 in three dimensions, i.e., in the spatial x, y, and z dimensions, as well as in time. Thus the remote participant 185 at the remote location 133 may view a moving 3-D image 175 of the local participant 107.

FIG. 4 illustrates an embodiment of a videoconferencing system that provides 3-D images of at least one participant to at least one other participant. FIG. 4 illustrates a local participant location 131 and a remote participant location 133. In this exemplary embodiment, an image of the local participant 107 at the local participant location 131 may be captured and the resulting data/signals may be processed to enable presentation of a 3-D image 175 of the local participant 107 to remote participants 175 at the remote participant location 133. In other words, remote participants 185 at the remote location 133 may see a 3-D image of the local participant 107.

The remote participant location 133 may have an apparatus for displaying 3-D images. More specifically, 3-D images 175 of the local participant 107 may be projected onto a rotating surface (e.g., a rotating disc 493) by a projector 195 to display the local participant 107 in three dimensions. The remote participant location 133 may have various projection/display equipment for displaying 3-D images. FIGS. 4-12 illustrate several alternative 3-D image display systems. Thus, the use and description of rotating disc 493 and accompanying projector is not intended to limit the invention to any particular 3-D display equipment.

In some embodiments, a camera, such as camera 123a, may capture an image of the local participant 107. In some embodiments, multiple cameras 123 (e.g., 123a and 123b) positioned at different points relative to the local participant 107 may be used to capture images of the local participant 107. In various embodiments 2, 3, 4, or more cameras may be used. These multiple images may be used to create a virtual 3-D image of the local participant 107. In some embodiments, a moving camera (e.g., a camera rotating around the local participant 107) may be used to capture various images of the local participant 107 to create a virtual 3-D image. In some embodiments, the camera 123 may be a video camera such as an analog or digital camera for capturing images.

The captured images may be processed locally at the participant location 131 where image capture is performed, or the captured images may be sent to the remote participant location 133 for processing and display. The captured images may also be sent to a third location to create a 3-D image. For example, the images may be digitized and sent over a network 101, e.g., the Internet, where they are processed and then transmitted to the remote participant location 133. In some embodiments, a codec 171 may be used to compress the image data prior to sending the data over a network 101. The codec 171 may also decompress received data.

In some embodiments, a computer 173 (which may be a codec) may manipulate the received image data into a form for displaying a 3-D image. For example, if using a rotating disc 493, the computer 173 may create image portions, based on the received image data, to project onto the rotating disc 493. The images may be synchronized with the rotating disc 493 such that a participant (e.g., remote participant 185 viewing local participant 107) perceives the images as a 3-D image 175 of the local participant 107. The computer 173 may determine images (e.g., portions of a 3-D image that corresponds with the current position of the rotating disc 493) to project onto the rotating disc 493 at appropriate intervals (e.g., every 0.1 seconds). The image may be recalculated by the computer 173 for each relative position of the rotating disc 493 such that a viewing participant perceives the overall series of images as a 3-D image of the remote participant 185. A projector, e.g., projector 195, may project the calculated images onto the rotating disc 493 to create the 3-D image 175.

The computer 173 may manipulate the received image data into a form for displaying a virtual 3-D image in any of various ways, as described above.

In some embodiments, a rotating disc 493 may move through a 3-D space in a rotating pattern. At each position in the rotation, a surface of the rotating disc 493 may occupy a planar segment of the 3-D space defined by the rotating disc 493. In some embodiments, the projector 195 may project an image portion of the 3-D image (e.g., as calculated by the computer 173 using received image data from a remote conference site) corresponding to the current planar segment occupied by the rotating disc 493 onto the rotating disc 493. In some embodiments, the delay between the different image portion projections may not be perceptible or may be insignificantly perceptible to local participant 107 such that the image portions appear to form a 3-D image. In some embodiments, the rotating disc 493 may rotate at least 30 rotations per second. Other rotation speeds are also contemplated. For example, the disc may rotate at less than one rotation per second or more than 100 rotations per second. In some embodiments, the rotating disc may be a double helix mirror rotating at 600 Hz.

In some embodiments, the computer 173 may portion the received image according to the size and speed of the rotating disc 493. In some embodiments, multiple cameras 123 may be used to capture various images of the local participant 107. A computer 173 may then compare the received images to determine a corresponding virtual image portion to project onto the rotating disc 493 at each disc position in the rotation. In some embodiments, multiple projectors may be used. The computer 173 may determine what images should be portrayed by each projector depending, for example, on the position and angle of the projector. Projector 191 may project a 3-D image (not shown) of the remote participant 185 for the local participant 107 to view.

In some embodiments, the projector 195 may be positioned approximately half way up the height of the rotating disc 493. Other positions are also contemplated. The projector may be mounted on a stand (e.g., stand 113 and pole 111 for projector 191). Other stands are also possible. In some embodiments, a camera 123 may be mounted near local participant 107 (e.g., the camera may be mounted on top of projector 191 (separated by pole 109)). Other placements of the camera 123 are also contemplated. In some embodiments, lasers and/or scanners may also be used to collect information about the participant to be displayed. Information from the lasers and/or scanners (for example, time of reflection off of the participant) may be sent in place of or in addition to the image information. In some embodiments, the computer 173 may process the data for display on the same side as the image information is collected. In some embodiments, the computer 173 receiving the image data from the remote participant location 133 may process the received data for displaying on the rotating disc 493.

In some embodiments, the rotating disc 493 may hang from a ceiling. In some embodiments, the rotating disc 493 may be rotated by a motor. Other rotation mechanisms are also contemplated. In some embodiments, microphones may be used to capture audio from a participant. The audio may be reproduced at the other conference locations. In some embodiments, the audio may be reproduced near the 3-D image. In some embodiments, the audio may be projected to appear as if the audio was from the 3-D image (e.g., using stereo speakers).

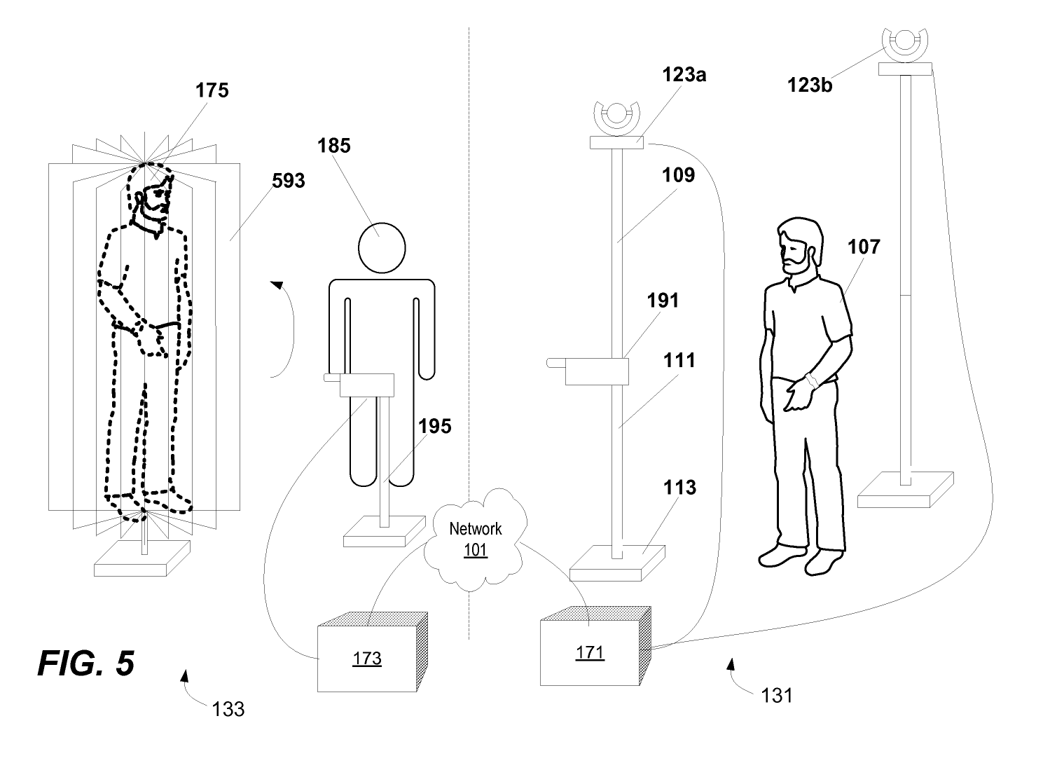

FIG. 5 illustrates an embodiment of a 3-D videoconference using a rotating panel 593. The image portions from the projector 195 may be timed with the positions of the rotating panel 593 to project the corresponding image portions onto the rotating panel 593 as the rotating panel 593 rotates through a 3-D space. In some embodiments, the images projected by the projector 195 may be synchronized with the rotating panel 593 such that the remote participant 185 may perceive a 3-D image of the local participant.

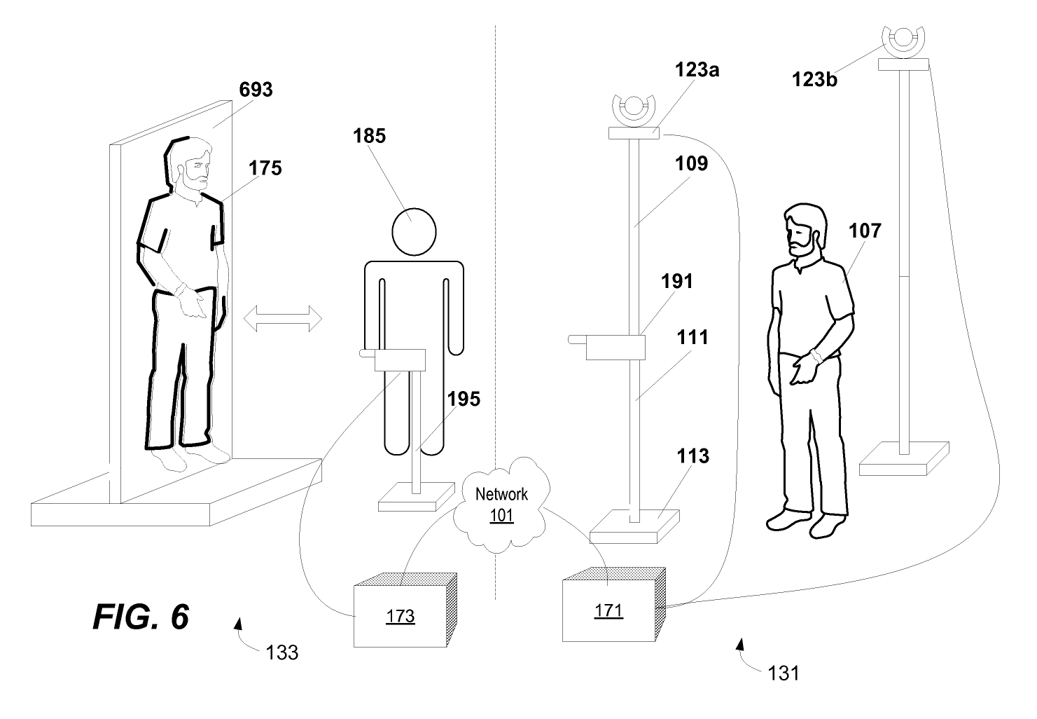

FIG. 6 illustrates an embodiment of a 3-D videoconference using an oscillating panel 693. In some embodiments, an image 175 may be projected onto a panel 693 moving back and forth in 3-D space. The computer 173 may determine which portion 385 of a 3-D image to project onto the oscillating panel 693 at each position of the panel 693 as it moves through the 3-D space. The delay between image projections may not be perceivable or may be insignificantly perceivable to the remote participant 185 such that the image projections appear as a 3-D image to the remote participant 185. In some embodiments, the panel may be a mirror vibrating at 30 Hz. In some embodiments, a varifocal mirror may be used. In some embodiments, image 175 may be a hologram projected onto panel 693 (which may or may not be moving).

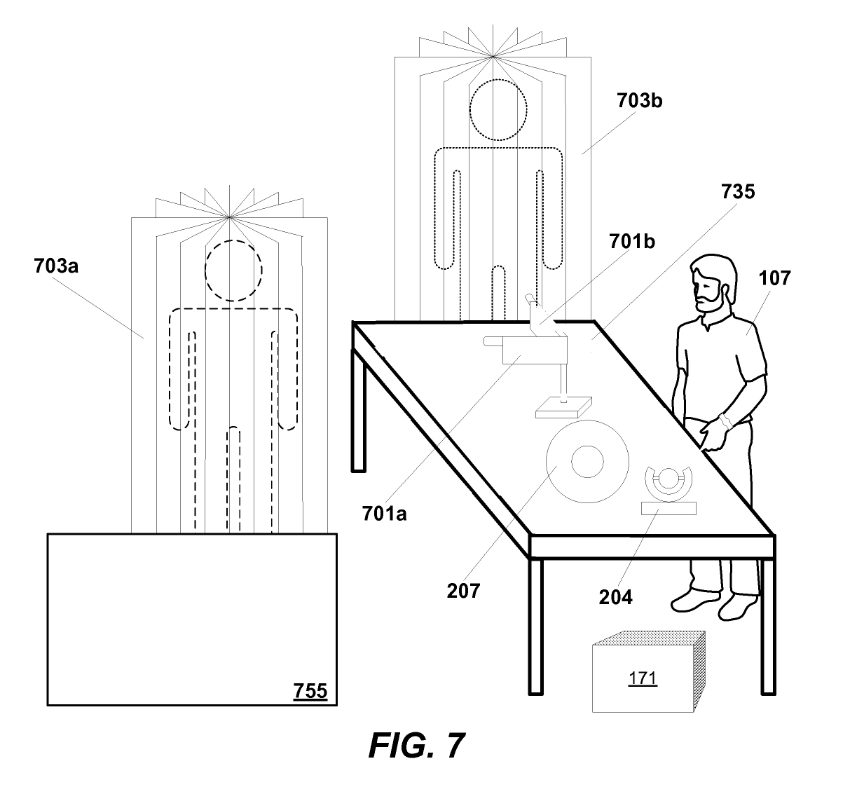

FIG. 7 illustrates an embodiment of a 3-D videoconference using multiple rotating panels 703 (e.g., panels 703a,b). In some embodiments, multiple rotating panels 703 may be used with multiple projectors 701 (e.g., projectors 701a,b) to display multiple remote participants. Other objects may also be displayed (e.g., in 3-D). In some embodiments, 3-D data plots may be displayed. In some embodiments, several or all of the items in a conference room may be projected (e.g., the conference table 735, participants 107, camera 204, speakerphone 207, etc.).

In some embodiments, safety barriers 755 may be placed around the rotating panels (e.g., panel 703a). In some embodiments, the rotating panels may be lightweight and configured to stop rotating if they encounter an external force greater than a predetermined amount (e.g., configured to stop rotating if someone bumps into it).

FIG. 8 illustrates an embodiment of a virtual 3-D videoconference. In some embodiments, 3-D images may be projected through virtual reality goggles 821. A virtual conference room (with virtual camera 843, display 841, sound system 851, speakerphone 849, and conference table 845) may be created for local and remote participants. In some embodiments, other 3-D reproduction medium may be used. For example, 3-D glasses may be used with a special screen image configured for viewing by 3-D glasses to create the effect of a 3-D image. In some embodiments, a liquid crystal display (LCD) may be used with special goggles that allow one of the participant's eyes to see the even columns and the other eye to see the odd columns. This effect may be used to create a 3-D image. Other 3-D imaging techniques may also be used.

The system and method described herein may also support various videoconferencing display modes, such as single speaker mode (displaying only a single speaker during the videoconference) and continuous presence mode (displaying a plurality or all of the videoconference participants at the same time as one or more of the participant locations. In a continuous presence mode, a participant location may include multiple (e.g., 2, 3, 4, etc.) 3-D display apparatus for displaying multiple remote participants in a continuous presence mode. The plurality of 3-D display apparatus may be displayed in a side-by-side fashion. Thus, if four participants are participating in a videoconference, a first participant location may display the other three participants, as well as the local participants from the first participant location, in a 3-D display format on separate display apparatus. In this example, the four different display apparatus may be arranged in a side-by-side arrangement. Alternatively, the four different display apparatus may be configured in a matrix of two rows and two columns, thus displaying the four participants in manner similar to how a conventional 2-D display would display 4 participants in a continuous presence mode, e.g., a 4-way split screen. In some embodiments, the different display apparatus may be positioned around a table (e.g., to display conference participants in 3-D at different conference participant locations).

Various other methods may also be used to view 3-D conferences. For example, 3-D conferences may be viewed on displays using field sequential techniques in which a display alternates between a left eye view and a right eye view while glasses on a participant alternate blocking the view of each eye. For example, LCD goggles may alternately “open” and “close” shutters in front of each eye to correspond with the left or right view (which is also alternating) on the display.

In some embodiments, the views may be polarized in orthogonal directions and the participant may wear passive polarized glasses with polarization axes that are also orthogonal. In some embodiments, (e.g., VREX micropolarizers from Reveo, Inc.) may be used to polarize the lines of a LCD to produce an image for the left eye polarized in a different direction than an image for the right eye (each image may use alternating lines of the LCD display). The participant may wear passive polarized glasses with polarization axes for viewing the left eye image with the left eye and the right eye image with the right eye. The left eye views image polarized along one axes and the right eye views images polarized along a different axes.

In some embodiments, an anaglyph method may be used to view a 3-D conference in which glasses with red and green lenses or filters (other colors may also be used) are used to filter images to each eye. In some embodiments, superchromatic prisms may be used to adjust the image for each eye to make an image appear in 3-D. Example systems include StereoGraphic CrystalEyes™, ZScreen™, and EPC-2™ Systems. Other systems include Fakespace Lab PUSH™, Boom™, and Immersadesk R2™. In some embodiments, a retinal sensor with a neutral density filter over one eye may use the Pulfrich technique to make an image appear in 3-D. In some embodiments, images may be displayed around a user to make the user feel as if they are in a virtual conference room. For example, systems such as the Fakespace CAVE™ and VisionDome™ systems could be used to project a conference room and the participants in the conference. In some embodiments, the output of a pair of video cameras may be alternated and displayed on screen (several frames of one camera followed by several frames of the other camera).

In some embodiments, 3-D conferences may be viewed using autostereoscopic displays in which each eye may view a different column of pixels to create the perception of three dimensions. In some embodiments, a multiperspective autostereoscopic display (e.g., a Dimension Technology Illuminator™ (DTI) system) places left eye images in one “zone” and right eye images in a separate “zone”. These zones are discernable to a person sitting in front of the display and create a 3-D image. For example, thin light lines may project even lines of a display to the left eye and odd lines to the right eye. Other displays (e.g., a Seaphone display, Sanyo 3-D display, etc.) may be used. In some embodiments, cameras may be used to track the eyes of a user to manipulate the display for projecting the correct images to each respective eye.

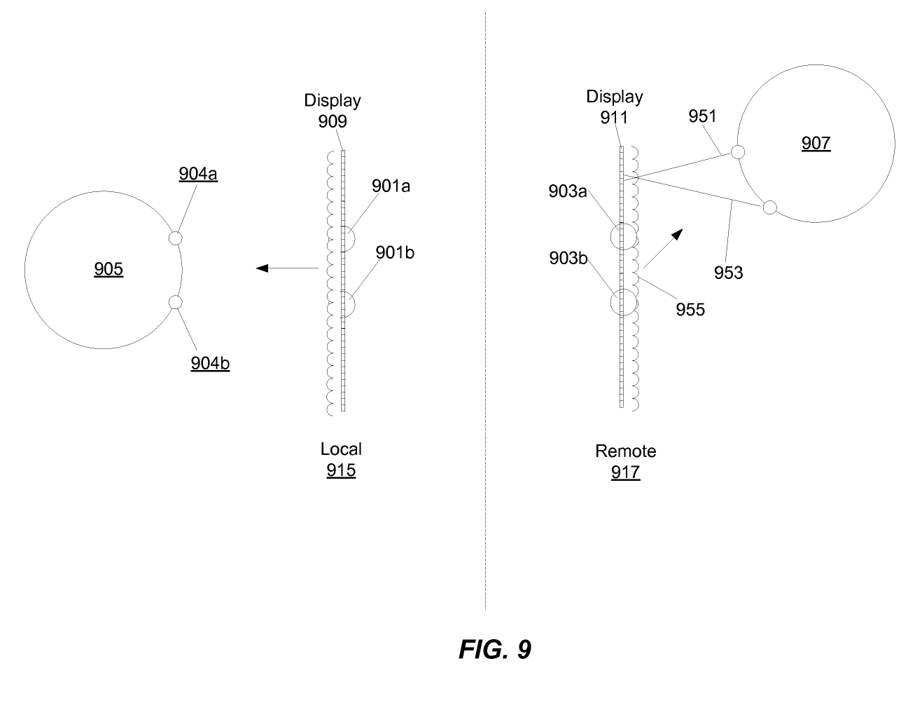

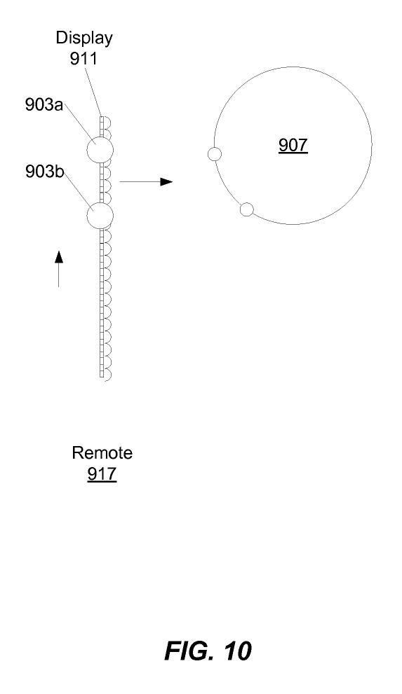

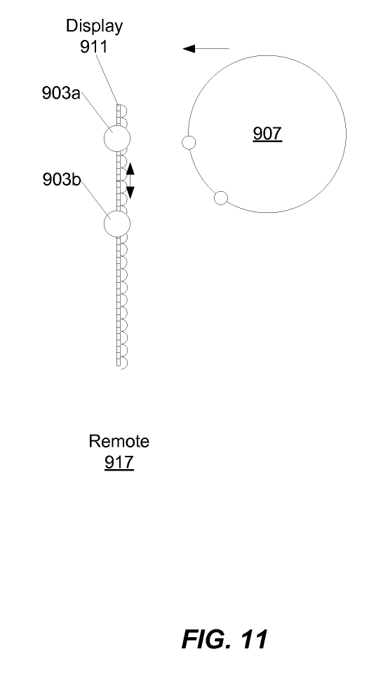

FIG. 9 illustrates an embodiment of local and remote autostereoscopic displays. In some embodiments, an autostereoscopic display (e.g., autostereoscopic display 909 at local participant location 915 and autostereoscopic display 911 at remote participant location 917) may display a different column of pixels to each eye to create a 3-D image. For example, a lenticular lens 955 may direct alternating columns of pixels (e.g., see separate paths 951 and 953) at separate eyes (e.g., eyes 904a, 904b) of the participant. Each column may include differences from the other columns such that when the columns received by each eye are resolved in the participant's brain to form a resolved image, the resolved image appears to be a 3-D image. In some embodiments, as seen in FIGS. 9-11, the cameras 901a, 901b, 903a, and 903b may detect the location of the eyes of a participant (e.g., participants 905 and 907) to place the columns of pixels relative to the position of the participant (for creating a 3-D image). In some embodiments, the cameras may move (e.g., see cameras 903a,b move between FIGS. 9 and 10) to properly display the columns of pixels to the opposite participant. In addition, as the participant moves closer or further from the display, the perspective of the participant changes. The displayed image perspective may be accordingly changed. As seen in FIG. 11, a remote autostereoscopic display's cameras 903a,b may be moved apart as a participant 907 gets closer to the display 911. In some embodiments, instead of moving the cameras, various pairs of cameras in an array of cameras may be used. In some embodiments, two cameras may be positioned at opposite edges and software may be used to create the correct virtual image depending on the location of the participant's head. In some embodiments, each camera may be a zoom camera capable of zooming in/out on objects. In some embodiments, the user may control the zoom (e.g., through software and/or a zoom knob). In some embodiments, an array of cameras may be used with separate pairs in the array following separate participants (or different pairs used for the same participant when the participant moves). Cameras may be used to track a participant's eyes in order to determine how to display the image such that the image will appear in 3-D to the participant in the participant's current position. The cameras may further move with the participant in order to properly display the participant to the opposite side.

In some embodiments an adjustable 3-D lenticular LCD display may be used with two cameras for both head tracking and input of the two images sent to the remote site. The horizontal position of the cameras on the display may be adjusted to match the participants relative position at the far site. The spacing of the two cameras and their position on the display may also allow a “3-D zoom”. For example, moving the cameras closer together may create a zoom out effect and moving the cameras farther apart may create a zoom in effect.

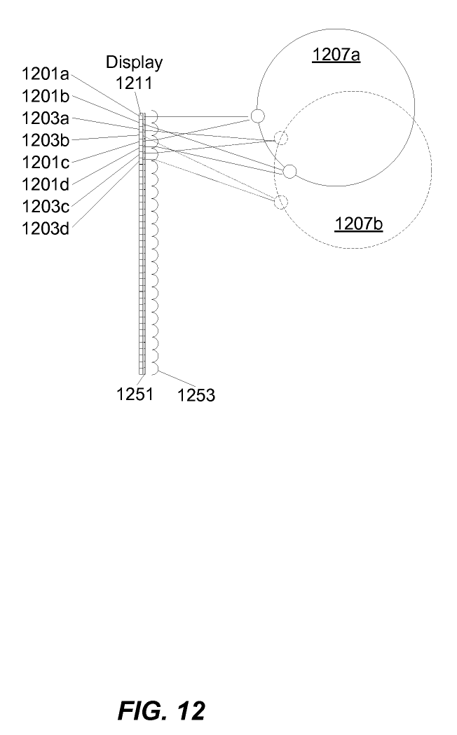

FIG. 12 illustrates another embodiment of an autostereoscopic display 1211. In some embodiments, the display may provide different positional views such that at specific locations relative to the screen, a participant can view a different perspective. For example, participant position 1207a may view an image provided by display portions 1201a, 1201b, 1201c, and 1201d, while participant position 1207b may view an image provided by display portions 1203a, 1203b, 1203c, and 1203d. In some embodiments, display portions 1201 may present a right angled view of a remote participant while display portions 1203 may present a straight on view of a remote participant. Other views are also possible. As seen in FIG. 12, each presented view may require multiple pixels (e.g., several columns of pixels). Therefore, in some embodiments, the resolution of each presented view may be 1/n the display resolution where n is the number of presented views (other resolutions are also contemplated). In some embodiments, a high definition display may be used to present the various views in a higher resolution than if a standard definition display was used to display the multiple views. In some embodiments, a material layer 1251 may include different materials over the different columns of the screen. Each material may reflect light at a different angle to create the various views from the relatively closely spaced display pixel columns. In some embodiments, the rounded lens layer 1253 may bend the light in addition to or in place of the material layer 1251.

As seen in FIG. 12, the autostereoscopic display may not use tracking cameras, but may instead present several fixed views. The viewing participant may then need to move into position to view one of the presented views. In some embodiments, tracking cameras may be used to align a presented view with the current location of the viewing participant's eyes. In some embodiments, the multiple views may be created by image processing input to one or more cameras. For example, two camera views may be image processed to generate three additional views to provide a total of five views on the autostereoscopic display on the remote side. Other numbers of cameras and image processed views are also contemplated.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for displaying a three dimensional (3-D) image of a participant in a videoconferencing system, the method comprising:
capturing an image of the participant at a first participant location, wherein the capturing produces first image data;
processing the first image data into processed image data viewable in a 3-D format;
displaying the processed image data at a second participant location in the 3-D format; and
wherein the displayed image data appears as a 3-D image to a participant at the second participant location in a videoconference.

2. The method of claim 1, further comprising transmitting the first image data over a network from the first participant location to the second participant location.

3. The method of claim 1, further comprising transmitting the processed image data over a network from the first participant location to the second participant location.

4. The method of claim 1, wherein the processing the first image data is performed at the first participant location.

5. The method of claim 1, wherein the processing the first image data is performed at the second participant location.

6. The method of claim 1,
wherein the processing the first image data includes forming image portions for projecting onto a moving surface; and
wherein the displaying comprises projecting the processed imaged data onto the moving surface.

7. The method of claim 6, wherein the moving surface is a panel rotating at least 30 rotations per second.

8. The method of claim 1, wherein displaying the processed image data at the second participant location comprises displaying the processed image data on an autostereoscopic display.

9. The method of claim 1, wherein displaying the processed image data at the second participant location comprises displaying the processed image data as a hologram.

10. The method of claim 1, wherein displaying the processed image data at the second participant location comprises displaying the processed image data through reality goggles.

11. The method of claim 1, wherein capturing the image comprises capturing at least two images using at least two video capture devices, and wherein the processed image data comprises data from the at least two images.

12. A videoconferencing system, comprising:
a video capture device for capturing an image of a videoconferencing participant;
a processor for processing the captured image into processed image data displayable in a three dimensional (3-D) format;
a 3-D image display device coupled to the processor; and
wherein the 3-D display device is operable to display processed image data to appear as a 3-D image to a participant in a videoconference.

13. The videoconferencing system of claim 12, wherein the processor is coupled to the video capture device through a network.

14. The videoconferencing system of claim 12, wherein the 3-D image display device comprises:
a projector;
a moving surface;
wherein the projector projects the processed image data onto the moving surface; and
wherein the projected processed image data on the moving surface appears as a 3-D image to the participant in the videoconference.

15. The videoconference system of claim 14, wherein the moving surface is a rotating panel.

16. The videoconference system of claim 14, wherein the moving surface is an oscillating panel.

17. The videoconference system of claim 12, wherein the 3-D image display device is an autostereoscopic display.

18. The videoconference system of claim 12, wherein the 3-D image display device is operable to display a hologram.

19. The videoconference system of claim 12, wherein the 3-D image display device is a pair of reality goggles.

20. The videoconference system of claim 12, comprising at least two video capture devices operable to capture at least two images using the at least two video capture devices, and wherein the processed image data comprises data from the at least two images.
